(19) United States
(12) Patent Application Publication
(10) Pub. No.: US 2017/0034611 A1
(43) Pub. Date: Feb. 2, 2017

(54) NEAR-EAR SPEAKER DEVICE

(71) Applicant: Seiji MARUYAMA, Tokyo (JP)

(72) Inventor: Seiji MARUYAMA, Tokyo (JP)

(21) Appl. No.: 15/304,233

(22) PCT Filed: Feb. 27, 2015
(86) PCT No.: PCT/JP2015/055775

§ 371 Date: Oct. 14, 2016

(30) Foreign Application Priority Data
Apr. 23, 2014 (JP) 2014-088759

(51) Int. Cl. H04R 1/10

(52) U.S. Cl. CPC H04R 1/105; H04R 2201/025

(57) ABSTRACT

An ear-mounted near-ear speaker apparatus includes: an ear hook that is semi-circular when viewed from the side and is hooked onto a root part of a user's auricle; and a speaker where a speaker body is housed in a casing attached to the ear hook. The ear hook includes: a contacting portion that contacts a side of the user's head when the near-ear speaker apparatus is worn by the user and keeps the speaker separated from the auricle; and a joint that enables the ear hook to deform so that a distance between a first end to which the speaker is attached and a second end at an opposite end to the first end changes.

### TECHNICAL FIELD

The present invention relates to a near-ear speaker apparatus configured to be capable of outputting audio from a speaker and to be worn on the head of the user.

### BACKGROUND ART

As an apparatus of this type, completely-open headphones were disclosed in the following patent document. These headphones include a headband that is formed in an arc that follows the shape of the upper head of the user and is equipped with slider holders at both ends, a pair of sliders that are held by the slider holders so as to be capable of sliding relative to the headband, a pair of jack/joint units that are respectively attached to lower ends of the sliders, and a pair of driver units that are attached to the jack/joint units via support pipes. The driver units each include a speaker that is connected to the jack of the lack/joint units and a case capable of housing a speaker.

In addition, with these headphones, side pads that are pressed onto the sides of the user's head by the elastic force of the headband and the two sliders are attached to inner positions on both sliders. Here, both side pads are formed so as to be elongated in a front-rear direction so as to hook onto root parts of the user's auricles, with ear hooks being provided at rear ends of the side pads so as to hook onto the rear sides of the root parts of the user's auricles. These headphones are configured so that in a state where the side pads are pressed against the sides of the user's head, both drivers are separated from the user's auricles. By doing so, it is possible to wear these headphones without experiencing discomfort due to both auricles being compressed.

### PRIOR ART DOCUMENTS

Patent Document 1

Japanese Utility Model No. S58-189691 (Pages 3 to 7, FIG. 1 to 4)

### SUMMARY OF THE INVENTION

### Problem to be Solved by the Invention

However, the headphones described above have the following, problem to be solved. With these headphones, a left unit composed of one of the two sliders, one of the two jack/joint units, one of the two driver units, and the like, and a right unit composed of the other of the two sliders, the other of the two jack/joint units, the other of the two driver units, and the like are connected by the headband. Accordingly, when worn, these headphones have the headband placed over the top of the head. This results in problems in that any hair that comes into contact with the headband when the headphones are worn will be disturbed and that the headband placed across the top of the head gets in the way and obstructs the wearing of a hat or a helmet.

Here, by sliding the sliders relative to the slider holders so that the headphones can be worn with the inner parts of the headband separated from the top of the head, it is possible to prevent disturbances to the user's hair. However, when worn in this way, only the side pads and ear hooks come into contact with the user, which is unstable and results in the risk of the headphones falling off the user's head. By changing the construction of the headphones so that the headband is positioned around the back of the head, it is possible to avoid a situation where the headband prevents the user from wearing a hat or a helmet. However, for headphones of this changed construction, there is the new problem of the headband getting in the way when the user wears the headphones while lying on his/her back or when the user sits in a chair with the back of the user's head in contact with a headrest.

The present invention was conceived in view of the problems described above and has a principal object of providing a near-ear speaker apparatus that is capable of being comfortably used even when the user is lying on his/her back and when the user is sitting on a chair with the back of his/her head in contact with a headrest while also being capable of not falling off unintentionally and avoiding disturbances to the hair and obstruction to the wearing of a hat or the like.

### Means for Solving the Problem

To achieve the stated object, the ear-mounted near-ear speaker apparatus according to the claim 1 comprises an ear hook that is semi-circular when viewed from the side and is hooked onto a root part of a user's auricle; and a speaker where a speaker body is housed in a casing attached to the ear hook, wherein the ear hook includes: a contacting portion that contacts a side of the user's head when the near-ear speaker apparatus is worn by the user and keeps the speaker separated from the auricle; and a joint that enables the ear hook to deform so that a distance between a first end to which the speaker is attached and a second end at an opposite end to the first end changes.

The near-ear speaker apparatus according to claim. 2 of the near-ear speaker apparatus according to the claim 1 has the ear hook provided with only one joint between the first and second ends.

The near-ear speaker apparatus according to claim 3 of the near-ear speaker apparatus according to the claims 1 and 2 has a biasing member, which biases both a first member on the first end-side and a second member on the second end-side that are connected via the joint in a direction that causes the ear hook to deform so that a distance between both ends becomes shorter, is disposed at the joint.

The near-ear speaker apparatus according to claim 4 of the near-ear speaker apparatus according to any of claim 1 to claim 3 has a speaker-end of a signal cable that supplies an audio signal to the speaker body of the speaker is buried in the ear hook and the signal cable is led outside the ear hook from a position that is closer to the first end than the joint that is closest to the first end of the ear hook.

The near-ear speaker apparatus according to claim 5 of the near-ear speaker apparatus according to any of claim 1 to claim 4, has the ear hook provided, at a position that coincides (when viewing from the side) with an arm of eyeglasses when the near-ear speaker apparatus is worn by a user that is wearing the eyeglasses, an arm clearance that forms a gap from a side of the user's head so as to avoid the arm.

### Effect of the Invention

According to the near-ear speaker apparatus according to the claim 1, unlike conventional headphones where a left unit and a et unit are connected via a headband, since are is no member positioned over the top or around the back of the head, it is possible to avoid disruptions to the hair and obstruction to the wearing of a hat or the like, and it is possible to comfortably use the apparatus when the user is lying on his/her back or sitting on a chair with the user's head in contact with a headrest. By causing the ear hook to deform, it is possible for a variety of users, from users where the diameter of the root part of the auricle is large to users where the diameter of the root part is small, to wear the apparatus. In addition, when worn by a user whose root part has a large diameter, the ear hook deforms so that the first end and the second end become separated, while when worn by a user whose root part has a small diameter, the ear hook deforms so that the first end and the second end approach each other so that the apparatus is worn in a state where inner parts of the ear hook favorably contacts an outer circumferential part of the root part. By doing so, it is possible to favorably prevent the apparatus from unintentionally falling off the user. Also, since a state where the speaker is separated from the auricle is maintained by the contacting portion, it is possible to use the apparatus comfortably with little pressure-based discomfort, even when worn for a long time.

According to the near-ear speaker apparatus according to claim 2, compared to a configuration where at least two joints are provided on the ear hook, it is possible to reduce the manufacturing cost of the near-ear speaker apparatus tv an amount corresponding to the reduction in the number of members constructing the ear hook. Also, when two joints are provided, for example, the ear hook may deform in a Z shape as unintended by the user, and although it is necessary to adjust the state (deformed state) of the ear hook so as to become U shaped when viewed from the side to attach the apparatus in a state where the ear hook favorably contacts the root part of the auricle, with the near-ear speaker apparatus where only one Mint is provided on the ear hook, it is possible to place the near-ear speaker apparatus in a state where both the member on the first end-side and the member on the second end-side connected by the joint favorably contact the root part of the auricle without causing a situation where the ear hook deforms into an unintended shape. This not only makes the apparatus easy to wear but also makes it possible to more favorably prevent the apparatus from unintentionally falling off the user.

According to the near-ear speaker apparatus according to claim 3, it is possible for the user to wear the near-ear speaker apparatus in a state where both the first member and the second member reliably contact the root part of the auricle and the root part is sandwiched between the first member and the second member, which makes it possible to more favorably prevent the apparatus from unintentionally falling off the user.

According to the near-ear speaker apparatus according to claim 4, the signal cable is separated from the joint of the ear hook and the member on the second end-side (the second member), which makes it possible to avoid the signal cable deforming together with the ear hook when the ear hook deforms at the joint. By doing so, it is possible to favorably avoid a situation where the signal cable becomes disconnected as a result of the ear hook becoming deformed a plurality of times.

According to the near-ear speaker apparatus according to claim 5, it becomes possible to attach the near-ear speaker apparatus in a suitable state for a user who is wearing the spectacles without being obstructed by the presence of the arm. By doing so, it is possible, even when the user is wearing the spectacles, to favorably prevent the near-ear speaker apparatus from unintentionally falling off.

### BRIEF DESCRIPTION OF THE DRAWINGS

FIG. 1 is a perspective view of a near-ear speaker apparatus 1.

FIG. 2 is another perspective view of the near-ear speaker apparatus 1.

FIG. 3 is a plan view of the near-ear speaker apparatus 1.

FIG. 4 is a side view of the near-ear speaker apparatus 1.

FIG. 5 is a side view of a state where the near-ear speaker apparatus 1 has been hooked onto an auricle 10 on the head of a user who is wearing the spectacles 15.

FIG. 6 is a plan view useful in explaining the positional relationship between the near-ear speaker apparatus 1 depicted in FIG. 5 and the arm 16 of the spectacles 15.

### DESCRIPTION OF THE INVENTION

Preferred embodiments of a near-ear speaker apparatus according to the present invention will now be described with reference to the attached drawings.

The configuration of a near-ear speaker apparatus 1 will be described first with reference to the drawings.

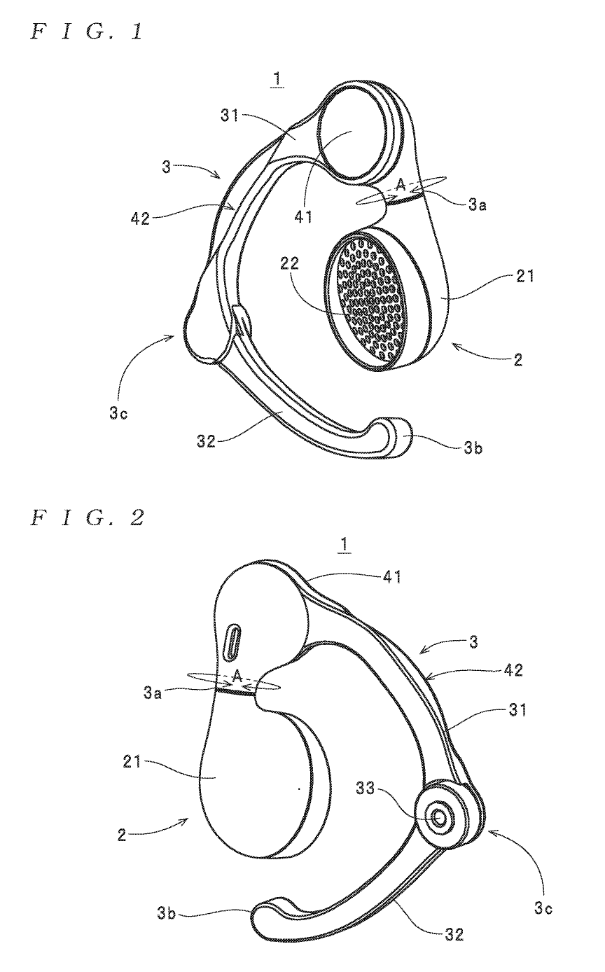

The near-ear speaker apparatus 1 is one example of an “ear-mounted near-ear speaker apparatus” and as depicted in FIGS. 1 and 2, is equipped with a speaker 2 and an ear hook 3. The near-ear speaker apparatus 1 is constructed so as to be capable of being worn on the side of the user's head (i.e., on the ear), and so as to be capable of outputting audio in keeping with an audio signal outputted from an audio signal output apparatus, not illustrated. Note that although the near-ear speaker apparatus 1 according to the present embodiment is constructed so as to be capable of being attached close to the left ear of the user as one example, when outputting audio in keeping with a stereo audio signal, the near-ear speaker apparatus 1 is used together with a “near-ear speaker apparatus”, not illustrated, that is equipped with a “speaker” and an “ear hook” in the same way as the near-ear speaker apparatus 1 according to the present embodiment and is constructed so as to be capable of being worn close to the right ear of the user.

The speaker 2 is constructed by housing a speaker body 22 (see FIG. 4) in a casing 21 attached to one end 3a of the ear hook 3. Here, with the near-ear speaker apparatus 1 according to the present embodiment, the speaker 2 is attached to the ear hook 3 so that the speaker 2 is capable of rotating relative to the ear hook 3 in the directions of the arrow. A depicted in FIGS. 1 and 2, and as described later, when the near-ear speaker apparatus 1 according to the present embodiment is worn on the side of the user's head, by orientating the speaker 2 toward the user's earhole, it is possible to make the audio audible to the user. Note that although various members aside from the speaker body 22, such as an enclosure and acoustic material, are also housed inside the casing 21, for ease of understanding the configuration of the near-ear speaker apparatus 1 according to the present embodiment, illustration and explanation of component elements aside from the speaker body 22 are omitted.

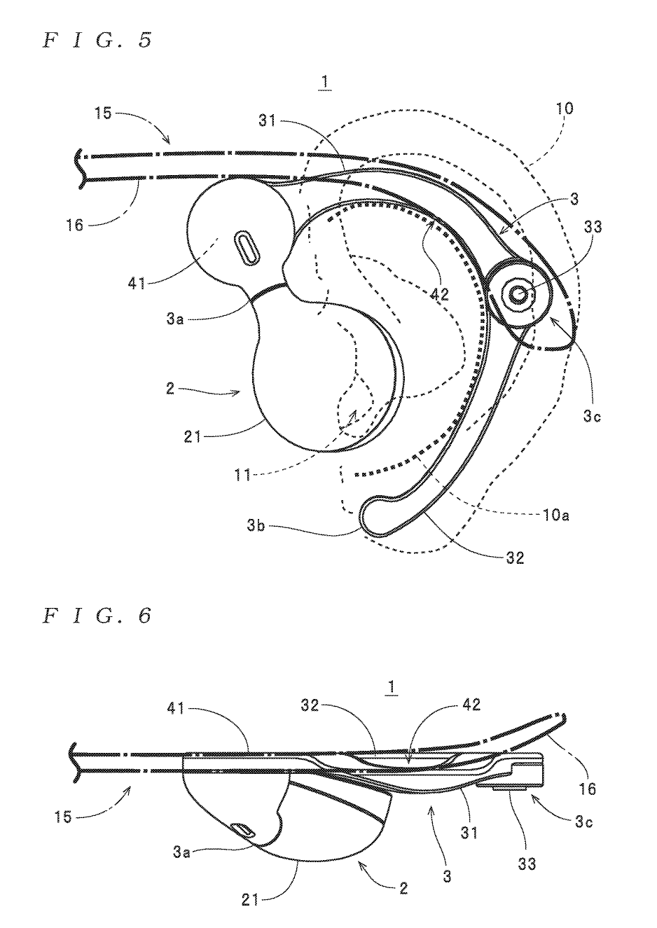

The ear hook 3 is equipped with a first member (or member on the “first end” side) 31 that is arc-shaped when viewed from the side, a second member (or member on the “second end” side) 32 that is also arc-shaped when viewed from the side, and a rotational shaft 33, and, as depicted in FIG. 5, has a semicircular form when viewed from the side (i.e., is C-shaped when viewed from the side) so as to be capable of being attached to a root part 10a of the user's auricle 10 when the near-ear speaker apparatus 1 according to the present embodiment is worn on the side of the user's head. With this ear hook 3, as depicted in FIGS. 1 and 2, ends of both the first member 31 and the second member 32 (non-deforming members) are connected by the rotational shaft 33 (i.e., the second member 32 is axially supported on the first member 31 by the rotational shaft 33). By doing so, with the near-ear speaker apparatus 1 according to the present embodiment, the ear hook 3 is configured so as to be capable of deforming (deformation by bending) so that the distance (linear distance or shortest distance) between the end. 3a to which the speaker 2 is attached (the end of the first member 31 at the opposite side to the second member 32 side: one example of a “first end”) and another end 3b disposed opposite (the end of the second member 32 on the opposite side to the first member 31 side: one example of a “second end”) is variable.

Here, with the ear hook 3 of the near-ear speaker apparatus 1 according to the present embodiment, only one joint 3c (or “rotational coupling”: one example of a “joint”) constructed by the rotational shaft 33, a bearing for the rotational shaft 33 on the first member 31 (i.e., the second member 32 side-end of the first member 31) and a bearing for the rotational shaft 33 on the second member 32 (i.e., the first member 31 side-end of the second member 32) is provided between the end 3a and the other end 3b. With this configuration, as depicted in FIG. 4, it is possible to rotate the second member 32 in the direction of the arrows B1 and B2 about the rotational shaft 33 relative to the speaker 2 and the first member 31. Also, with the ear hook 3 according to the present embodiment, a coil spring 34 (one example of a “biasing member”) that biases both the first member 31 and the second member 32 that are connected via the rotational shaft 33 to cause deformation of the ear hook 3 so as to reduce the distance between the end 3a and the other end 3b is disposed in the periphery of the rotational shaft 33 of the joint 3c.

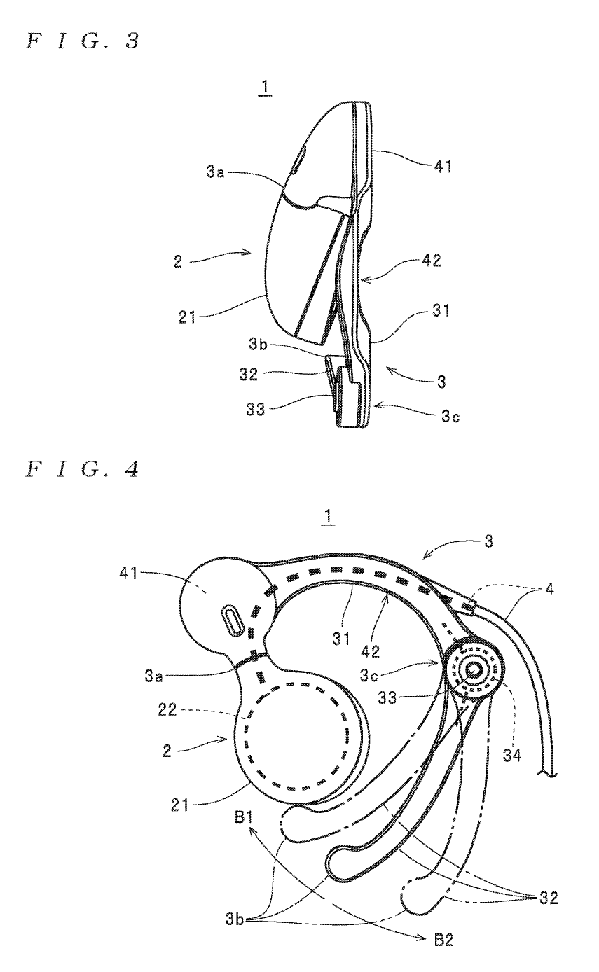

As depicted in FIG. 1, a contacting portion 41 for maintaining a state where, as described later, when worn, the near-ear speaker apparatus 1 contacts the side of the user's head (the user's temple) with the speaker 2 separated from the user's auricle (as one example, a state where the speaker 2 is close to but is separated by 0.3 to 2 cm inclusive from the rim of the earhole 11) is provided on the first member 31. In addition, as depicted in FIGS. 3 and 6, an arm clearance 42 that becomes coincident when looking from the side) with an arm 16 of spectacles 15 when the near-ear speaker apparatus 1 is worn by a user who is wearing the spectacles 15 is provided on the first member 31 so as to produce a gap between the ear hook 3 (the first member 31) and the side of the user's head, which makes it possible to avoid the arm 16.

Also, as depicted in FIG. 4, with the near-ear speaker apparatus 1 according to the present embodiment, a speaker 2-side end of the signal cable 4 that supplies an audio signal to the speaker body 22 is buried inside the ear hook 3 (i.e., inside the first member 31), and the signal cable 4 is lead to the outside of the ear hook 3 (the first member 31) from a position closer to the end 3a than the joint 3c (one example of a “joint closest to the first end”).

Next, the method of using the near-ear speaker apparatus 1 will be described with reference to the attached drawings.

As described earlier, with the near-ear speaker apparatus 1 according to the present embodiment where the first member 31 and the second member 32 of the ear hook 3 are biased by the coil spring 34, when not being worn, the second member 32 is positioned relative to the speaker 2 and the first member 31 at the position depicted by the dot-dash line in FIG. 4, so that the end. 3a and the other end 3b of the ear hook 3 are close to one another. Accordingly, when the near-ear speaker apparatus 1 is put on, first the second member 32 is rotated about the center of rotation of the rotational shaft 33 relative to the first member 31 in the direction of the arrow B2 against the biasing force of the coil spring 34, so that the ear hook 3 deforms and the end 3a and the other end 3b become separated as depicted by the dot-dot-dash line in FIG. 4.

Next, the near-ear speaker apparatus 1 is inserted over the root part 10a of the user's auricle 10 diagonally from the rear and, as depicted in FIG. 5, the near-ear speaker apparatus 1 is released from the hand in a state where the speaker 2 is positioned to the side of the earhole 11 and an inner part of the first member 31 of the ear hook 3 contacts the root part 10a. At this time, the second member 32 is caused to rotate in the direction of the arrow B1 depicted in FIG. 4 about the rotational shaft 33 relative to the speaker 2 and the first member 31 by the biasing force of the coil spring 34, so that as depicted in FIG. 5, the ear hook 3 deforms so that the end 3a and the other end 3b approach one another. By doing so, a state is produced where at least one position on an inner part of the first member 31 and at least one position on an inner part of the second member 32 contact the root part 10a of the user's auricle 10 and the root part 10a of the auricle 10 is sandwiched between the first member 31 and the second member 32.

Also, in the state where the root part 10a of the auricle 10 is sandwiched between the first member 31 and the second member 32, the contacting portion 41 of the first member 31 contacts the side of the user's head (the user s temple) so that the speaker 2 becomes separated from auricle 10 (the rim of the earhole 11). By doing so, the near-ear speaker apparatus 1 is positioned on the user's head in a state where at least one position on an inner part of the first member 31, at least one position on an inner part of the second member 32, and at least three positions on the contacting portion 41 of the first member 31 contact the user.

Here, as described earlier, with the near-ear speaker apparatus 1 according to the present embodiment, the arm clearance 42 is provided on the first member 31 of the ear hook 3. Accordingly, as depicted in FIGS. 5 and 6, when the near-ear speaker apparatus 1 is worn by a user who is wearing the spectacles 15, a gap is produced between the side of the user's head and the first member 31 at the position of the arm clearance 42 and the arm 16 of the spectacles 15 becomes positioned in this cap, which means that it is possible to wear the near-ear speaker apparatus 1 without interfering with the arm 16. After this, by rotating the speaker 2 relative to the ear hook 3 to rotate the speaker body 22 toward the earhole 11, attachment of the near-ear speaker apparatus completed. That is, the speaker 2 becomes positioned close to but separated from the auricle 10 (the rim of the earhole 11). After this, by outputting an audio signal from an audio signal output apparatus connected to the near-ear speaker apparatus audio is outputted from the speaker 2 (the speaker body 22).

Here, known ear-mounted “near-ear speaker apparatuses” include apparatuses where the speaker is inserted into the earhole 11. However, with a near-ear speaker apparatus where the speaker is inserted into the earhole 11, since the presence of the inserted “speaker” means that the rim of the earhole 11 is pressed in directions so as to widen, the user will experience discomfort when the apparatus is worn for a long time. On the other hand, with the near-ear speaker apparatus 1 according to the present embodiment that is worn in a state where the speaker 2 is separated from the auricle 10, even when used for a long time, it is possible to use the near-ear speaker apparatus 1 comfortably with little pressure-based discomfort.

In this way, according to the near-ear speaker apparatus 1, by using a configuration where the speaker 2 is attached to the ear hook 3, which includes the contacting portion 41, which contacts the side of the user's head and maintains the state where the speaker 2 is separated from the auricle 10, and the joint 3c, which makes it possible for the ear hook 3 to deform so that the distance between the end 3a to which the speaker 2 is attached and the other end 3b at the opposite end changes, unlike conventional headphones where a left unit and a right unit are connected via a headband, since there is no member positioned over the top or around the back of the head, it is possible to avoid disruptions to the hair and obstruction to the wearing of a hat or the like, and it is possible to comfortably use the apparatus when the user is lying on his/her back or sitting on a chair with the user's head in contact with a headrest. By causing the ear hook 3 to deform, it is possible for a variety of users, from users where the diameter of the root part 10a of the auricle 10 is large to users where the diameter of the root part 10a is small, to wear the apparatus 1. In addition, when worn by a user whose root part 10a has a large diameter, the ear hook 3 deforms so that the end 3a and the other end 3b become separated, while when worn by a user whose root part 10a has a small diameter, the ear hook 3 deforms so that the end 3a and the other end 3b approach each other so that the apparatus 1 is worn in a state where inner parts of the ear hook 3 favorably contacts an outer circumferential part of the root part 10a. By doing so, it is possible to favorably prevent the apparatus 1 from unintentionally falling off the user. Also, since a state where the speaker 2 is separated from the auricle 10 is maintained by the contacting portion 41, it is possible to use the apparatus 1 comfortably with little pressure-based discomfort, even when worn for a long time.

According to the near-ear speaker apparatus 1, since only one joint 3c is provided between the end portions 3a and 3b of the ear hook 3, compared to a configuration where at least two joints are provided on the ear hook, it is possible to reduce the manufacturing cost of the near-ear speaker apparatus 1 by an amount corresponding to the reduction in the number of members constructing the ear hook 3. Also, when two “joints” are provided, for example, the ear hook may deform in a Z shape as unintended by the user, and although it is necessary to adjust the state (deformed state) of the ear hook so as to become U shaped when viewed from the side to attach the apparatus 1 in a state where the ear hook favorably contacts the root part 10a of the auricle 10, with the near-ear speaker apparatus 1 where only one joint 3c is provided on the ear hook 3, it is possible to place the near-ear speaker apparatus 1 in a state where both the first member 31 and the second member 32 connected by the joint 3c favorably contact the root part 10a of the auricle 10 without causing a situation where the ear hook 3 deforms into an unintended shape. This not only makes the apparatus easy to wear but also makes it possible to more favorably prevent the apparatus 1 from unintentionally falling off the user.

In addition, according to the near-ear speaker apparatus 1, by disposing the coil spring 34, which biases the first member 31 and the second member 32 in a direction where the ear hook 3 deforms so that the distance between the ends 3a and 3b of the ear hook 3 becomes shorter, on the joint 3c, it is possible for the user to wear the near-ear speaker apparatus 1 in a state where both the first member 31 and the second member 32 reliably contact the root part 10a of the auricle 10 and the root part 10a is sandwiched between the member 31 and 32, which makes it possible to more favorably prevent the apparatus 1 from unintentionally falling off the user.

Also, according to the near-ear speaker apparatus 1, by burying the speaker 2-end of the signal cable 4 in the ear hook 3 and leading the signal cable 4 outside the ear hook 3 from a position closer to the end 3a than the joint 3c, the signal cable 4 is separated from the joint 3c of the ear hook 3 and the second member 32, which makes it possible to avoid the signal cable 4 deforming together with the ear hook 3 when the ear hook 3 deforms at the joint 3c. By doing so, it is possible to favorably avoid a situation where the signal cable 4 becomes disconnected as a result of the ear hook 3 becoming deformed a plurality of times.

In addition, according to the near-ear speaker apparatus 1, by providing the arm clearance 42 that forms a gap from the side of the user's head at a position that coincides, when looking from the side, with the arm 16 of the spectacles 15 so as to avoid the arm 16 when the near-ear speaker apparatus 1 is worn by a user who is wearing the spectacles 15, it becomes possible to attach the near ear speaker apparatus 1 in a suitable state for a user who is wearing the spectacles 15 without being obstructed by the presence Of the arm 16. By doing so, it is possible, even when the user is wearing the spectacles 15, to favorably prevent the near-ear speaker apparatus 1 from unintentionally falling off.

Note that the configuration of the “near-ear speaker apparatus” is not limited to the configuration of the near-ear speaker apparatus 1 described above. As one example, although an example has been described where the coil spring 34 is disposed as a “biasing member” at the joint 3c that is constructed by the rotational shaft 33, the bearing for the rotational shaft 33 on the first member 31, and the bearing for the rotational shaft 33 on the second member 32, it is also possible to use a configuration where a “biasing member” aside from the coil spring 34 (for example, a plate spring) is provided at the “joint” and a configuration where a “biasing member” is not provided at the “joint”. When using a configuration where no “biasing member” is provided, as examples it is preferable for the “Mint” to be configured by connecting the “first member” and the “second member” via a “rotational shaft” and to use a configuration that prevents unintentional deformation (by bending) of the ear hook 3 due to sliding resistance produced between the “first member” and the “second member”.

Also, in place of a “joint” constructed by the rotational shaft 33 and the like, it is possible to use a configuration (not illustrated) where as one example the “ear hook” is integrally molded to produce a state where both the “first member” and the “second member” (non-deforming parts) are connected by a “reduced thickness (i.e., deforming) part”, and to have the “reduced thickness part” function as the “joint” so that the “ear hook” is capable of deformation (by bending) to change the distance between the “first end” and the “second end”. In addition, although a configuration equipped with the ear hook 3 provided with only one joint 3c between the end. 3a and the other end. 3b has been described, it is also possible to construct the “ear hook” by providing two or more “joints” between the “first end” and the “second end” (not illustrated).

### DESCRIPTION OF REFERENCE NUMERALS

1: Near-ear speaker apparatus
2: Spaker
3: Ear hook
3a: One end
3b: Other end
3c: Joint
4: Signal cable
10: Auricle
10a: Root part
11: Earhole
15: Spectacles
16: Arm
21: Casing
22: Speaker body
31: First member
32: Second member
33: Rotational shaft
34: Coil spring
41: Contacting portion
42: Arm clearance

1. An ear-mounted near-ear speaker apparatus, comprising:
an ear hook that is semi-circular when viewed from the side and is hooked onto a root part of a user's auricle; and
a speaker where a speaker body is housed in a casing attached to the ear hook,
wherein the ear hook includes:
a contacting portion that contacts a side of the user's head when the near-ear speaker apparatus is worn by the user and keeps the speaker separated from the auricle; and
a joint that enables the ear hook to deform so that a distance between a first end to which the speaker is attached and a second end at an opposite end to the first end changes.

2. The near-ear speaker apparatus according to claim 1,
wherein the ear hook is provided with only one joint between the first and second ends.

3. The near-ear speaker apparatus according to claim 1,
wherein a biasing member, which biases both a first member on the first end-side and a second member on the second end-side that are connected via the joint in a direction that causes the ear hook to deform so that a distance between both ends becomes shorter, is disposed at the joint.

4. The near-ear speaker apparatus according to claim 1,
wherein a speaker-end of a signal cable that supplies an audio signal to the speaker body of the speaker is buried in the ear hook and the signal cable is led outside the ear hook from a position that is closer to the first end than the joint that is closest to the first end of the ear hook.

5. The near-ear speaker apparatus according to claim 1,
wherein the ear hook is provided, at a position that coincides (when viewing from the side) with an arm of eyeglasses when the near-ear speaker apparatus is worn by a user that is wearing the eyeglasses, an arm clearance that forms a gap from a side of the user's head so as to avoid the arm.

6. The near-ear speaker apparatus according to claim 2,
wherein a biasing member, which biases both a first member on the first end-side and a second member on the second end-side that are connected via the joint in a direction that causes the ear hook to deform so that a distance between both ends becomes shorter, is disposed at the joint.

7. The near-ear speaker apparatus according to claim 2,
wherein a speaker-end of a signal cable that supplies an audio signal to the speaker body of the speaker is buried in the ear hook and the signal cable is led outside the ear hook from a position that is closer to the first end than the joint that is closest to the first end of the ear hook.

8. The near-ear speaker apparatus according to claim 3,
wherein a speaker-end of a signal cable that supplies an audio signal to the speaker body of the speaker is buried in the ear hook and the signal cable is led outside the ear hook from a position that is closer to the first end than the joint that is closest to the first end of the ear hook.

9. The near-ear speaker apparatus according to claim 6,
wherein a speaker-end of a signal cable that supplies an audio signal to the speaker body of the speaker is buried in the ear hook and the signal cable is led outside the ear hook from a position that is closer to the first end than the joint that is closest to the first end of the ear hook.

10. The near-ear speaker apparatus according claim 2,
wherein the ear hook is provided, at a position that coincides (when viewing from the side) with an arm of eyeglasses when the near-ear speaker apparatus is worn by a user that is wearing the eyeglasses, an arm clearance that forms a gap from a side of the user's head so as to avoid the arm.

11. The near-ear speaker apparatus according claim 3,
wherein the ear hook is provided, at a position that coincides (when viewing from the side) with an arm of eyeglasses when the near-ear speaker apparatus is worn by a user that is wearing the eyeglasses, an arm clearance that forms a gap from a side of the user's head so as to avoid the arm.

12. The near-ear speaker apparatus according claim 4,
wherein the ear hook is provided, at a position that coincides (when viewing from the side) with an arm of eyeglasses when the near-ear speaker apparatus is worn by a user that is wearing the eyeglasses, an arm clearance that forms a gap from a side of the user's head so as to avoid the arm.

13. The near-ear speaker apparatus according claim 6,
wherein the ear hook is provided, at a position that coincides (when viewing from the side) with an arm of eyeglasses when the near-ear speaker apparatus is worn by a user that is wearing the eyeglasses, an arm clearance that forms a gap from a side of the user's head so as to avoid the arm.

14. The near-ear speaker apparatus according claim 7,
wherein the ear hook is provided, at a position that coincides (when viewing from the side) with an arm of eyeglasses when the near-ear speaker apparatus is worn by a user that is wearing the eyeglasses, an arm clearance that forms a gap from a side of the user's head so as to avoid the arm.

15. The near-ear speaker apparatus according claim 8,
wherein the ear hook is provided, at a position that coincides (when viewing from the side) with an arm of eyeglasses when the near-ear speaker apparatus is worn by a user that is wearing the eyeglasses, an arm clearance that forms a gap from a side of the user's head so as to avoid the arm.

16. The near-ear speaker apparatus according claim 9,
wherein the ear hook is provided, at a position that coincides (when viewing from the side) with an arm of eyeglasses when the near-ear speaker apparatus is worn by a user that is wearing the eyeglasses, an arm clearance that forms a gap from a side of the user's head so as to avoid the arm.
